(19) United States
(12) Patent Application Publication
(10) Pub. No.: US 2011/0214152 A1
(43) Pub. Date: Sep. 1, 2011

(54) Application Execution System for Digital Television, Apparatus for Application Execution for Digital Television and Method to Implement Said System

(76) Inventors: Weber George Canova, Barueri (BR); David Estevam de Britto, Itaipu (BR); Marcio Antonio Ramos Alves, Recreio (BR); Aquinaldo Rangel Boquimpani, Rio de Janeiro (BR); Hernan Rafael Perrone, Rio de Janeiro (BR); Alexandre de Azevedo Moreira, Rio de Janeiro (BR); David Campelo, Rio de Janeiro (BR); Fabiano Ramos, Recrio dos Bandeirantes (BR); Heitor Jose Miranda de Almeida, Niteroi (BR)

(21) Appl. No.: 13/061,834

(22) PCT Filed: Aug. 18, 2009
(86) PCT No.: PCT/BR2009/000258

§ 371 Date: May 10, 2011

(30) Foreign Application Priority Data
Sep. 3, 2008 (BR) PI0803717-5

(51) Int. Cl. H04N 7/173

(52) U.S. Cl. 725/63; 725/132

(57) ABSTRACT

The present invention refers to a system for executing applications, wherein said system is organized by layers and is designed to be used in an open broadcasting television system (land or satellite), and said system is capable of allowing the execution of applications produced by television broadcasters in the different hardware present in the Set-top Box and/or television set present at the viewer's residence.

### FIELD OF THE INVENTION

The present invention refers to a system for executing applications, wherein said system is organized by layers and is designed for use in an open broadcasting digital television system (land or satellite), and said system is capable of allowing the execution of applications produced by the television broadcasters independently in the different hardware present in the Set-top Box and/or television sets present at the viewer's residence.

### BACKGROUND OF THE INVENTION

### Digital TV

Digital TV is a television system with digital broadcast, reception and processing, and in the end user receiver, the shows can be exhibited by way of entirely digital equipment or through analogical apparatus coupled to converter units (known as IRD—Integrated Receiver Decoder and Set Top Box—STB).

Digital Television can be redefined as being the broadcast in digital form. This system enhances the guarantee of better quality picture and sound for the viewer. Furthermore, the picture can be wider (widescreen—16:9 format) than the current format (4:3 format), and may have a higher definition and a surround stereo sound, in multiple channels, such as, for example 5.1 channels, being able to reach up to 8 channels.

Digital television will offer interactivity. Furthermore, digital technology opens up a large spectrum of new possibilities:
i) The digitalization of audio and video signals will improve the picture quality with increased immunity to noise and distortion;
ii) Better sound quality, with audio treatment, allows bass and trebles enhanced;
iii) Better use of the radioelectric spectrum, thus providing increased robustness against interferences, enabling reception with lower field intensity values, higher quantity of information transmitted in the same frequency range;
iv) Flexibility in handling and improving the treatment and editing of signals;
v) Capacity to transport multiple programs with video, several audios, text, data and applications;
vi) Interactive services.

Architecture of the Digital TV System

Similarly to the OSI model for Computer Networks, the architectural model of a digital TV system is split into layers. They have autonomy and provide or receive services from the neighboring layers. Besides the modulation/transmission and demodulation/reception functions known in conventional TV, compression/decompression and middleware functions are introduced. Middleware is placed between the transport layer and the interactive applications.

Middleware

Middleware is a generic term normally used for a method of connecting applications, and acts as a mediator between two existing and independent programs. Its purpose is to provide independence of applications from the broadcast system. It enables various application codes to work with different reception equipment (URDs). By creating a virtual machine in the receiver, the application codes are compiled in a suitable format for each operating system. In short, it can be said that middleware enables the execution of a code for different types of reception platforms (URDs) or vice-versa.

Connecting applications was necessary to solve the new paradigm introduced by Digital TV: combining traditional TV (broadcasting) with interactivity, texts and graphics. This interactivity will require various characteristics and functionalities, found in the Internet environment: graphic representation; user identification; friendly navigation and use, among others.

Therefore, application developers stopped being concerned about the existing protocols in the lower layers of the transmission system and focused on a standard interface to develop their work. HTML and Java are accepted formats in most application connection methods in use. Furthermore, the Web presentation format provides a high degree of familiarity for the user and through a return channel, enables an environment of interaction with the receiver, thus revolutionizing the TV system. A system that basically just disseminated information now allows the receiver to interact with the broadcaster.

Document WO 00/72583 describes software architecture for a terminal of cable TV subscribers comprising components such as abstraction layers of operating system, services relating to sound, video and graphics, among others. The present invention differs from this document, among other aspects, by having an architecture designed for viewers of open broadcasting television systems.

Document WO 99/35569 describes a convergence system that provides functionalities thus far only found in separate systems, enabling the user to have the functionalities of a television set and a computer in a single equipment. The present invention differs from this document, among other aspects, by having an architecture designed for a unique system capable of broadcasting data/images/sound/videos, as opposed to two separate systems.

Therefore, it can be seen that the state of the art has no published document which anticipates or suggests the objects described in the present invention.

### SUMMARY OF THE INVENTION

In an aspect of the present invention, a system of executing applications created for digital TV and the target platforms, capable of showing said applications is provided, as well as apparatus of executing the applications. Examples of apparatus include decoders that can be implemented inside television sets.

It is therefore an object of the present invention to provide a system of executing applications which is a layer-organized system comprising:
a layer of standard language components;
a common core, comprising the components required by the established standard language;
a portability layer, comprising components so that no effort is required to execute the applications on different platforms; and
a layer comprising target platform components.

It is an additional object of the present invention to provide an apparatus to execute applications comprising:
a computer-legible means containing programming code means;
means for executing said programming codes to implement a layer-organized system comprising:
   a layer of standard language components;
   a common core, comprising the components required by the established standard language;
   a portability layer, comprising components so that no effort is required to execute the applications on different platforms; and
   a layer comprising target platform components.

In another aspect of the present invention, a method for implementing the execution system for applications is provided.

Therefore, it is an additional object of the present invention to provide a method for implementing an execution system for layer-organized applications comprising the steps of:

a) providing a computer-legible means comprising program code means; and

b) executing said program code means so as to implement a layer-organized system comprising:
a layer of standard language components;
a common core, comprising the components required by the established standard language;
a portability layer, comprising components so that no effort is required to execute the applications on different platforms; and
a layer comprising target platform components.

### DESCRIPTION OF THE DRAWINGS

FIG. 1 describes a scheme of the layer-organized system according to the present invention, wherein: Ginga-J (1), ARIB B23 (2), JavaTV (3), JavaDTV (4), LWUIT (5), ISDB-TB (6), Events Bus (7); Bridge (8); Lua-Java (9); Ginga-NCL (10); Lua (11), XHTML environment (12); AstroNAV (13), Astro Faces (14); OS Abstraction Layer (15), Portability Layer graphics manager (16), Portability Layer Input Manager (17), Portability Layer Screen Manager (18), Tuner (19), Video Decoder (20), Audio Decoder (21), Video Output (22), Audio Output (23), DEMUX/Section filter (24); Java Virtual Machine—JVM (25); Common Core (26): Applications Manager (27), Service Selector (28), Components Manager (29), Resources Manager (30), Security Manager (31), Return Channel Manager (32), General Services, (33), Graphics manager (34), Input Manager (35), Screen Manager (36) Network Manager (37), Media Manager (38), Stream Events (39), Objects Carrousel (40), Data Carrousel (41), DSM-CC (42), Service Information (43), Section filter (44); General Support Libraries (XML, Security, etc.) (45), Graphic Libraries/IU (46), DTV API and Controllers (47); Operating System (48), Hardware (49).

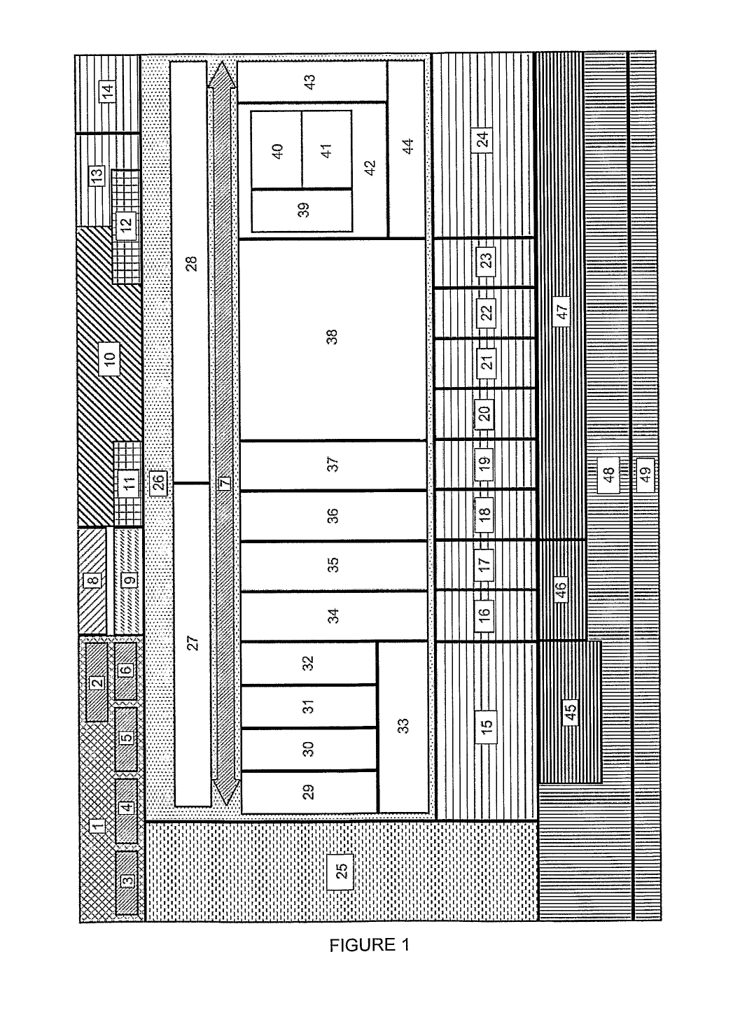

### DETAILED DESCRIPTION OF THE INVENTION

The following examples are solely intended to exemplify certain aspects of the present invention, without limiting it.

Standard Norm

The Standard Norm is the specification chosen for each existing digital television system. Particularly, Ging a is used in Brazil.

In this embodiment, the common core will comprise the components necessary to provide support for the Brazilian Digital TV System, which comprises Ginga-NCL declarative environment, the Lua scripting language, the Ginga-J imperative environment, composed of various components such as ARIB B23, JavaTV, JavaDTV, LWUIT, ISDB-TB, the XHTML environment and the Bridge that links the declarative and imperative environments.

Target Platform

The target platform is a certain hardware configuration, operating system, device drivers and application program interfaces (API), provided by the platform manufacturer. The target platform is chosen from the group comprising, but not limited to, televisions, computers, mobile communication devices such as cellphones, set-top boxes.

In most cases, the hardware comprises tuners, MPEG-2 demultiplexers, audio and video decoders, mixers for the video and graphics layers, audio and video output controls, return channel, among others.

The APIs of the manufacturers mostly comprise libraries, graphics, user and general support interfaces, written in programming languages such as, for example C or C++, or even interfaces for native software components built into the receiver, which should provide methods for accessing and/or controlling various devices such as, for example: tuners, MPEG-2 demultiplexers, decoder, mixer and audio and video output, graphic layers, USB port connection, ethernet, serial port connection (RS-232), communication via infrared for remote controls, among others. They should also provide mechanisms for: initiating the hardware devices, sending a transport stream by software on the MPEG-2 demultiplexer, sending an audio/video track by software to the audio/video decoder, creating/configuring the audio/video decoding, section filtering the Transport Stream MPEG-2, among others. Examples of some APIs include the components AstroNAV (13) and Astro Faces (14).

The operating system is any set of programs that allows an interface between the user and the hardware operations. Examples of operating systems include, but are not limited to, Linux and variations or distributions thereof, Windows and versions thereof such as Windows CE, Symbian, among others.

Common Core

Common Core components include all components required to give support to the functionalities defined in the Standard Norm. In order to minimize the adaptation effort of the application communication method to be integrated with other target platforms, those common core components that are designed to provide an abstraction of the target platform functionalities are placed in the Portability Layer.
a) components manager: this component enables dynamic downloading and initialization of the components of the common core and the Portability Layer.
b) resource manager: this component allows management of scarce resources (such as the tuner, interactivity channel, screen layout, section filters, etc.) of the systems, guaranteeing exclusive access thereto.
c) memory manager: this component is designed to manage the memory allocations and to control the use limits of this resource so as to guarantee that the memory quantity available for executing the system is not exceeded.
d) events bus: this component is responsible for managing the events that are generated by the different components of the execution system, notifying all those components or applications that were subscribed to be notified thereby.
e) applications manager: this component is designed to manage all the applications that are based on the common core. Applications include:
   Interactive Broadcasted Applications executed in the Ginga-NCL presentation environment or in the Ginga-J execution environment
   External Applications executed in the Ginga-NCL presentation environment or in the Ginga-J execution environment
   Resident or Built-In Applications executed in the Ginga-NCL presentation environment or in the Ginga-J execution environment
   Native Resident or Built-In Applications based on the common core
   Native External Applications based on the common core
f) DSM-CC: the objective of this component is to interpret the MPEG2-TS sections that transport content on the DSM-CC protocol. This component is capable of interpreting the following protocols:
   DSMCC Data Carrousel
   DSMCC Objects Carrousel
   DSMCC Stream Events
   DSMCC NPT
   Multi-protocol encapsulation (IP/TCP/UDP)
g) Service Information: the responsibility of this component is to interpret the MPEG2-TS sections corresponding to the Service Information tables and provide this information to the other components of the common core and those components based thereon.
h) security manager: this component is responsible for authenticating the application that will be executed on the Ginga-J or Ginga-NCL environments and define the permissions for said applications. Additionally this component should also be responsible for managing certificates.
i) Service Selector: the objective of this component is to centralize the display control of the different components of the services that can be provided through Digital TV.

The common core additionally comprises other components, such as, for example: return channel manager, graphics manager, input manager, screens manager, network manager and media manager.

Portability Layer

A portability layer is a layer with lower-level components capable of creating an abstraction of the functionalities supplied by the target platform, thus allowing easy and fast integration of the execution system with different target platforms.

An interface is defined between the common core components and the Portability Layer components such that, without having to know the characteristics or the specific working details of the Target Platform, the following is possible:
the common core components can call upon the functionalities of the Target Platform;
the Portability Layer components can notify the common core components of asynchronous events or notices occurring on the Target Platform.

For each specific Target Platform in which integration of the execution system is desired, exclusive implementations of the Portability Layer components must be provided so as to interact with the interface referred to above.

The portability layer is subdivided into 2 different large groups, each having subsequent divisions:

a) General Abstraction Components:

a.1) operating system abstraction layer—this component (which can be divided into various sub-components) offers an abstraction for diverse functionalities such as management of threads, synchronization, communication between processes, TCP/UDP sockets, access to the files system, among others, independently from the operating system present. The objective of this component is to enable all the common core components and other components based thereon to be entirely independent from the type of Operating System used in the different Target Platforms.

a.2) graphics abstraction layer (graphic management)—this component offers an access interface to the graphic functionalities and image decoding, creating an abstraction of the graphics system and libraries present on the target platform, such as, for example, DirectFB, SDL, Windows' GDI.

In the event that the target platform hardware provides more than a graphic layer, one of the layers would be reserved for the execution system whereas the others would be used by the resident in the native OSD, thus avoiding competition for the graphic layer. If there is only one graphic layer, competition would be managed by the target platform.

a.3) data input—this component offers an interface so that common core and other components based thereon can receive data input events from users originating from various devices such as keyboards, remote controls or pointer devices such as the mouse.

a.4) interactivity (return) channel—this component allows the abstraction of different devices and technologies that can be used by the target platform as interactivity channel. The main objective of this component is so that common core can request connection or disconnection of said interactivity channel line.

a.5) Java virtual machine—this component allows the abstraction for use is by different implementations of Java virtual machines.

b) Abstraction Components of the Digital TV Functionalities:

b.1) audio output—this component offers an interface to control the mixer and audio output, such as, for example, tuning the audio output and volume control channels.

b.2) audio reproduction—this component offers an interface to control the audio decoder, where examples of its abstracted functionalities include the start and end of decoding of an audio track present in the TS or in a file, audio file and synthesized sounds reproduction.

b.3) video output—this component offers an interface to control the video mixer to manage the compositions of layers and the video output, where examples of its abstracted functionalities include order configuration and combinations, digital and/or analogical output control, video resolution selection. Some examples of resolutions include, but are not limited to 480i, 480p, 576i, 576p, 720p and/or 1080i.

b.4) video reproduction—this component offers an interface to control the decoder and video display of the target platform, where examples of its abstracted functionalities include the start and end of the decoding of a video track present on the TS or in a file, and also has the possibility of controlling the position of the video on the screen.

b.5) subtitles reproduction (screens manager)—this component offers an interface to control the decoder and subtitles display of the target platform, where examples of its abstracted functionalities include the start and end of decoding of a subtitles track on the TS or in a file, and also has the possibility of controlling the position of the subtitles on the screen.

b.6) tuner—this component enables access and control of different tuners present on the target platform, through an interface that allows the selection of frequencies, or even a sweeping in a range of frequencies, and blocking in a certain frequency when the TS is received.

b.7) DEMUX/section filter—The section filter offers an interface to TS section filtering, through the use/combination of the following items: Packet Identifier (PID), table identifier, section version, section number, or a positive/negative mask. The DEMUX offers an interface that allows the selection of different elementary data streams for directing to suitable components (eg. video stream dispatch to the video decoder).

In a preferred embodiment, the apparatus of the present invention is a digital TV converter apparatus, or can also be built into various platforms such as, for example television sets, mobile communication devices and computers.

Particularly, said apparatus comprises:
a computer-legible means containing programming code means;
means for executing said programming codes to implement a layer-organized system comprising:
   a layer of standard language components;
   a common core, comprising the components required by the established standard language;
   a portability layer, comprising components so that no effort is required to execute the applications on different platforms; and
   a layer comprising target platform components.
      wherein the definitions of the characteristics of each layer are described above, and the apparatus has the capacity of executing applications created for digital TV.

The method of implementing the system of the present invention comprises the execution of instructions relating to each of the components. In a preferred embodiment, the method comprises the steps of:

a) providing a computer-legible means comprising program code means; and

b) executing said program code means so as to implement a layer-organized system comprising:
a layer of standard language components;
   a common core, comprising the components required by the established standard language;
a portability layer, comprising components so that no effort is required to execute the applications on different platforms; and
a layer comprising target platform components.

1. Execution system of applications for digital television characterized by comprising:
a layer of standard language components;
a common core, comprising the components required by the established standard language;
a portability layer, comprising components so that no effort is required to execute the applications on different platforms; and
a layer comprising target platform components.

2. Execution system, according to claim 1, characterized wherein the digital TV is an open broadcasting television system.

3. Execution system, according to claim 1, characterized wherein the television system is broadcasted by land and/or satellite.

4. Execution system, according to claim 1, characterized wherein the target platform is chosen from the group comprising television sets, computers, mobile communication devices, set-top boxes and combinations thereof.

5. Execution system, according to claim 1, characterized wherein the target platform comprises a hardware chosen from a group comprising tuners, MPEG-2 demultiplexers, audio and video decoders, mixers for the video and graphics layers, audio and video output controls, return channel and combinations thereof.

6. Execution system, according to claim 1, characterized by the standard language components are chosen from the group comprising Ginga-NCL declarative environment, the Lua scripting language, the Ginga-J imperative environment, the XHTML navigator and the Bridge that links the declarative and imperative environments.

7. Execution system, according to claim 1, characterized by the common core components are chosen from the group comprising components manager, resources manager, memory manager, events bus, applications manager, DSM-CC, service information, security manager, service selector, return channel manager, graphics manager, input manager, screens manager, network manager, media manager and combinations thereof.

8. Execution system, according to claim 1, characterized wherein the portability layer components are chosen from the group comprising operating system abstraction layer; at least a graphics abstraction layer, data input, interactivity channel, Java virtual machine and combinations thereof.

9. Execution system, according to claim 1, characterized wherein the components of the portability layer are chosen from the group comprising output and/or audio play components, output and/or video play components; subtitles play, tuner, DEMUX, section filter and combinations thereof.

10. Apparatus to execute applications for digital television characterized by comprising:
a) a computer-legible means containing programming code means;
b) means for executing said programming codes to implement a layer-organized system comprising:
a layer of standard language components;
a common core, comprising the components required by the established standard language;
a portability layer, comprising components so that no effort is required to execute the applications on different platforms; and
a layer comprising target platform components;

11. Apparatus, according to claim 10, characterized wherein the digital TV is an open broadcasting television system.

12. Apparatus, according to claim 10, characterized wherein the television system is broadcasted by land and/or satellite.

13. Apparatus, according to claim 10, characterized wherein the target platform is chosen from the group comprising television sets, computers, mobile communication devices, set-top boxes and combinations thereof.

14. Apparatus, according to claim 10, characterized wherein the target platform comprises hardware chosen from a group comprising tuners, MPEG-2 demultiplexers, audio and video decoders, mixers for the video and graphics layers, audio and video output controls, return channel and combinations thereof.

15. Apparatus, according to claim 10, characterized wherein the standard language components are chosen from the group comprising Ginga-NCL declarative environment, the Lua scripting language, the Ginga-J imperative environment, the XHTML navigator and the Bridge that links the declarative and imperative environments.

16. Apparatus, according to claim 10, characterized wherein the common core components are chosen from the group comprising components manager, resources manager, memory manager, events bus, applications manager, DSM-CC, service information, security manager, service selector, return channel manager, graphics manager, input manager, screens manager, network manager, media manager and combinations thereof.

17. Apparatus, according to claim 10, characterized wherein the portability layer components are chosen from the group comprising operating system abstraction layer; at least a graphics abstraction layer, data input, interactivity channel, Java virtual machine and combinations thereof.

18. Apparatus, according to claim 10, characterized wherein the portability layer components are chosen from the group comprising audio output and/or play components, video output and/or play components; subtitles play, tuner, DEMUX, section filter and combinations thereof.

19. Apparatus, according to claim 10, characterized by its capacity to execute applications created for digital TV.

20. Implementation method of an execution system characterized by comprising the steps of:
a) providing a computer-legible means comprising program code means; and
b) executing said program code means so as to implement a layer-organized system comprising:
a layer of standard language components;
a common core, comprising the components required by the established standard language;
a portability layer, comprising components so that no effort is required to execute the applications on different platforms; and
a layer comprising target platform components.

21. Implementation method, according to claim 20, characterized wherein the digital TV is an open broadcasting television system.

22. Implementation method, according to claim 20, characterized wherein the television system is broadcasted by land and/or satellite.

23. Implementation method, according to claim 20, characterized wherein the target platform is chosen from the group comprising televisions, computers, mobile communication devices, set-top boxes and combinations thereof.

24. Implementation method, according to claim 20, characterized wherein the target platform comprises hardware chosen from a group comprising tuners, MPEG-2 demultiplexers, audio and video decoders, mixers for the video and graphics layers, audio and video output controls, return channel and combinations thereof.

25. Implementation method, according to claim 20, characterized wherein the standard language components are chosen from the group comprising Ginga-NCL declarative environment, the Lua scripting language, the Ginga-J imperative environment, the XHTML navigator and the Bridge that links the declarative and imperative environments.

26. Implementation method, according to claim 20, characterized wherein the common core components are chosen from the group comprising components manager, resources manager, memory manager, events bus, applications manager, DSM-CC, service information, security manager, service selector, return channel manager, graphics manager, input manager, screens manager, network manager, media manager and combinations thereof.

27. Implementation method, according to claim 20, characterized wherein the portability layer components are chosen from the group comprising operating system abstraction layer; at least a graphics abstraction layer, data input, interactivity channel, Java virtual machine and combinations thereof.

28. Implementation method, according to claim 20, characterized wherein the portability layer components are chosen from the group comprising audio output and/or play components, video output and/or play components; subtitles play, tuner, DEMUX, section filter and combinations thereof.
